(19) United States
(12) Patent Application Publication
(10) Pub. No.: US 2020/0241694 A1
(43) Pub. Date: Jul. 30, 2020

(54) PROXIMITY DETECTION DEVICE AND PROXIMITY DETECTION METHOD

(71) Applicant: Mitsubishi Electric Corporation, Tokyo (JP)

(72) Inventor: Eishi ODA, Tokyo (JP)

(73) Assignee: Mitsubishi Electric Corporation, Tokyo (JP)

(21) Appl. No.: 16/755,238

(22) PCT Filed: Dec. 4, 2017
(86) PCT No.: PCT/JP2017/043499

§ 371 Date: Apr. 10, 2020

(51) Int. Cl. G06F 3/042; G06F 3/044; G06F 3/01

(52) U.S. Cl. CPC G06F 3/0421; G06F 2203/04101; G06F 3/017; G06F 3/044

(57) ABSTRACT

The followings are included: a capacitive sensor (101) having a detection region that extends in a parallel direction with respect to an operation surface (301) for accepting a 3D gesture by an operation body, the detection region being in an area close to the operation surface (301); and an infrared sensor (102) having a detection region having directivity in a direction perpendicular to the operation surface (301). The capacitive sensor (101) and the infrared sensor (102) are arranged such that a 3D gesture by the operation body can be detected in the parallel direction and the perpendicular direction with respect to the operation surface (301).

### TECHNICAL FIELD

The present invention relates to a technique for detecting proximity of an operation body in an operation area.

### BACKGROUND ART

In a related art, there is technology for operating an input device by touching an operation surface with a finger. Input operation of touching an operation surface with a finger is detected by a capacitive sensor. When a finger is detached from a touch surface, it is not possible to detect the finger by the capacitive sensor, and thus there is technology for complementing measurement values using an infrared sensor when the finger is detached from the touch surface.

For example, an input device disclosed in Patent Literature 1 includes: a capacitive sensor which is arranged on the lower side of an operation area and can detect the operation position of an operation body; and an infrared sensor including a light emitting element and a light receiving element which are arranged below the operation area. The infrared sensor complements the operation position by detecting the operation position of the operation body that is slightly away from the operation surface by receiving, by the light receiving element, reflected light caused by light emitted from the light emitting element to the operation surface. As a result, when a finger as the operation body was touching the operation surface to perform touch operation and then is detached slightly from the operation surface, the operation position of the detached finger can be detected by the infrared sensor to complement the operation position to enable detection of continuous operation positions.

### CITATION LIST

### Patent Literature

Patent Literature 1: JP 2013-58117 A

### SUMMARY OF INVENTION

### Technical Problem

The input device described in Patent Literature 1 listed above can complement the operation position when the operation body is detached from the operation surface by a slight distance during touch operation. However, since the light emitting element and the light receiving element are arranged below the operation area, the reflected light by the operation body cannot be received in a case where the separation distance between the operation body and the operation surface is large. Therefore, there is a disadvantage that it cannot be applied to proximity detection technology having a different purpose from that of the technology disclosed in Patent Literature 1, that is, technology for detecting the proximity of an operation body to an operation surface in a state where there is a distance between the operation body and the operation surface and no touch operation is performed.

The present invention has been made to solve the disadvantage as described above, and it is an object of the present invention to detect the proximity of an operation body to an operation surface using a capacitive sensor and an infrared sensor and to expand the detection region for detecting the proximity and to improve the detection accuracy.

### Solution to Problem

A proximity detection device according to the present invention includes: at least one capacitive sensor having a detection region that extends in a parallel direction with respect to an operation surface for accepting a 3D gesture by an operation body, the detection region being in an area close to the operation surface; and at least one infrared sensor having a detection region having directivity in a direction perpendicular to the operation surface. The at least one capacitive sensor and the at least one infrared sensor are arranged such that the 3D gesture by the operation body can be detected in the parallel direction and the perpendicular direction with respect to the operation surface.

### Advantageous Effects of Invention

According to the present invention, it is possible to detect the proximity of an operation body to an operation surface and to expand a detection region for detecting the proximity and to improve the detection accuracy.

### BRIEF DESCRIPTION OF DRAWINGS

FIG. 1 is a diagram illustrating exemplary arrangement of sensors included in a proximity detection device according to a first embodiment.

FIG. 2 is a diagram illustrating detection regions of a capacitive sensor and infrared sensors included in the proximity detection device according to the first embodiment.

FIG. 3 is a diagram illustrating detection regions of capacitive sensors and infrared sensors included in the proximity detection device according to the first embodiment.

FIG. 4 is a block diagram illustrating a configuration of the proximity detection device according to the first embodiment.

FIGS. 5A and 5B are diagrams each illustrating an exemplary hardware configuration of the proximity detection device according to the first embodiment.

FIG. 6 is a graph illustrating relationship between relative sensitivity of a capacitive sensor and relative sensitivity of an infrared sensor in an area other than the four corner areas of a display of the proximity detection device according to the first embodiment.

FIG. 7 is a graph illustrating relationship between relative sensitivity of the capacitive sensor and relative sensitivity of the infrared sensor in the four corner areas of the display of the proximity detection device according to the first embodiment.

FIG. 8 is a flowchart illustrating an operation of the proximity detection device according to the first embodiment.

FIG. 9 is a diagram illustrating another exemplary arrangement of sensors included in the proximity detection device according to the first embodiment.

### DESCRIPTION OF EMBODIMENTS

To describe the present invention further in detail, an embodiment for carrying out the present invention will be described below with reference to the accompanying drawings.

### First Embodiment

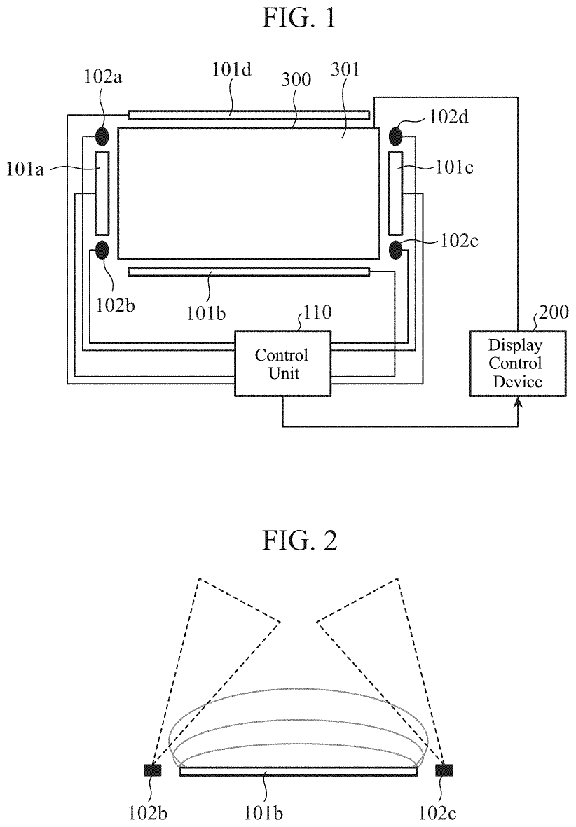

FIG. 1 is a diagram illustrating exemplary arrangement of sensors included in a proximity detection device 100 according to a first embodiment.

In the example shown in FIG. 1, four capacitive sensors 101a, 101b, 101c, and 101d (hereinafter referred to as the capacitive sensors 101 when collectively referred to) and four infrared sensors 102a, 102b, 102c, and 102d (hereinafter referred to as the infrared sensors 102 when collectively referred to) are arranged around an operation surface 301 of a display 300. FIG. 1 is a view of the display 300 as viewed from above, and the operation surface 301 is a flat surface that extends above the display 300.

The four capacitive sensors 101a, 101b, 101c, and 101d are arranged so that the longitudinal directions thereof extend along the four sides of the outer circumference of the operation surface 301, respectively. The four infrared sensors 102a, 102b, 102c, and 102d are arranged near the four corners of the operation surface 301, respectively. In the example shown in FIG. 1, the infrared sensor 102a and 102b are arranged at positions sandwiching the capacitive sensor 101a, the infrared sensors 102b and 102c are arranged at positions sandwiching the capacitive sensor 101b, the infrared sensors 102c and 102d are arranged at positions sandwiching the capacitive sensor 101c, and the infrared sensors 102d and 102a are arranged at positions sandwiching the capacitive sensor 101d. As a result, the capacitive sensors 101 and the infrared sensors 102 are alternately arranged on the outer circumference of the operation surface 301.

Measurement values of the capacitive sensors 101 and measurement values of the infrared sensors 102 are input to a control unit 110 of the proximity detection device 100. Details of the control unit 110 will be described later. A display control device 200 is connected to the control unit 110 and the display 300. The connection between the display control device 200 and the control unit 110 and the connection between the display control device 200 and the display 300 may be wireless or wired. The display control device 200 generates control information for controlling display screen on the display 300 on the basis of information input from the control unit 110. The display 300 is a display mounted on an onboard device, for example.

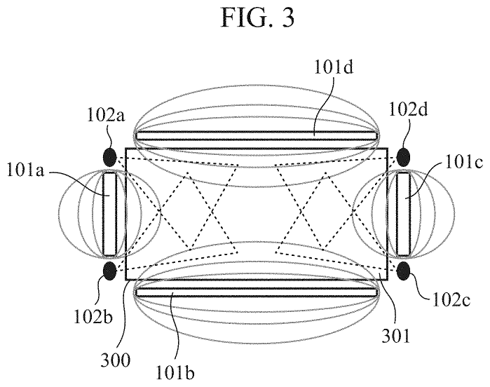

FIGS. 2 and 3 are diagrams illustrating detection regions of the capacitive sensors 101 and the infrared sensors 102 included in the proximity detection device 100 according to the first embodiment.

FIGS. 2 and 3 show detection regions in the case where the capacitive sensors 101 and the infrared sensors 102 are arranged in the exemplary arrangement illustrated in FIG. 1. In the example shown in FIGS. 2 and 3, the detection regions of the capacitive sensors 101 are indicated by solid lines and the detection regions of the infrared sensors 102 are indicated by dotted lines. FIG. 2 shows the detection regions of the capacitive sensors 101 and the infrared sensors 102 when the display 300 is viewed from a side. FIG. 3 shows the detection regions of the capacitive sensors 101 and the infrared sensors 102 when the display 300 is viewed from the above.

First, referring to FIG. 2 and FIG. 3, the detection regions in the direction orthogonal to the operation surface 301 (hereinafter referred to as the perpendicular direction) and a direction in which the operation surface 301 extends (hereinafter referred to as the parallel direction) will be described.

Each of the capacitive sensors 101 has a perpendicular direction region limited to the vicinity of the arranged sensor, while has a parallel detection region extending in the longitudinal direction of the arranged sensor. On the other hand, each of the infrared sensors 102 has the detection region in which directivity is limited in the parallel direction, while has widened detection region in the perpendicular direction. By limiting the directivity of the detection regions of the infrared sensors 102, non-detection areas occur in areas near the arrangement positions of the infrared sensors 102. The non-detection areas of the infrared sensors 102 are complemented by detection by the capacitive sensors 101 in the parallel direction.

Furthermore, since the perpendicular direction regions of the capacitive sensors 101 are limited to the vicinity of the arranged sensors, a region separated from the operation surface 301 by a certain distance in the perpendicular direction is a non-detection area of the capacitive sensors 101. The non-detection areas of the capacitive sensors 101 are complemented by detection by the infrared sensors 102 in the perpendicular direction. Since the detection regions of the capacitive sensors 101 and the infrared sensors 102 complement each other, the detection region can be expanded in the perpendicular and parallel directions with respect to the operation surface 301 as illustrated in FIGS. 2 and 3.

Note that the capacitive sensors 101 and the infrared sensors 102 are set in such a manner that enables detection of operation by an operation body such as a user's finger approaching a point about 10 to 20 cm away from the operation surface 301, for example (hereinafter, such an operation is referred to as a 3D gesture). The distance from the operation surface 301 to the operation body is merely an example and can be modified as appropriate depending on the performance of the sensors or other factors.

As illustrated in FIGS. 2 and 3, the detection regions of the capacitive sensors 101 and the detection regions of the infrared sensors 102 are different. Therefore, the control unit 110 of the proximity detection device 100 switches between measurement values of the capacitive sensors 101 and measurement values of the infrared sensors 102 depending on detection characteristics of the respective sensors and calculates coordinate values indicating the proximity position of the operation body.

Next, details of the control unit 110 of the proximity detection device 100 will be described.

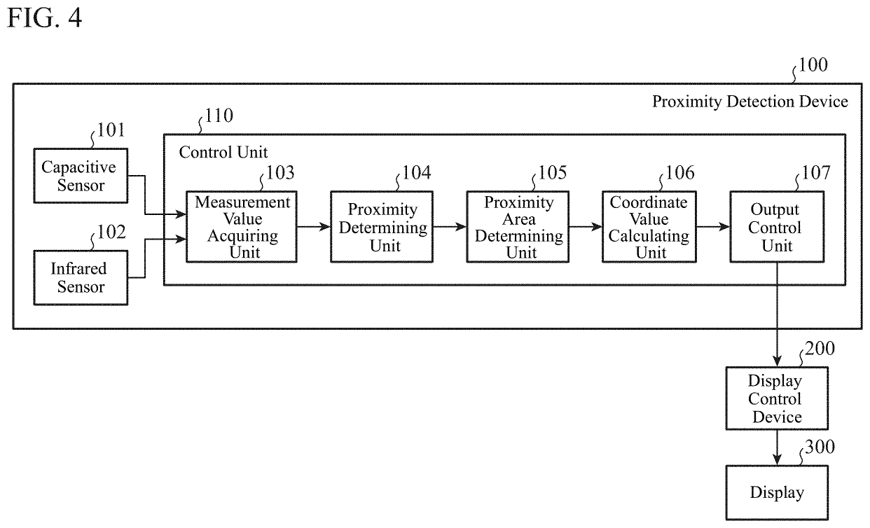

FIG. 4 is a block diagram illustrating the configuration of the proximity detection device 100 according to the first embodiment.

The proximity detection device 100 includes the capacitive sensors 101, the infrared sensors 102, a measurement value acquiring unit 103, a proximity determining unit 104, a proximity area determining unit 105, a coordinate value calculating unit 106, and an output control unit 107.

The measurement value acquiring unit 103, the proximity determining unit 104, the proximity area determining unit 105, the coordinate value calculating unit 106, and the output control unit 107 correspond to the control unit 110 illustrated in FIG. 1. The proximity detection device 100 is connected to the display control device 200, and the display control device 200 performs control for displaying information on the display 300.

The capacitive sensors 101 output measurement values to the measurement value acquiring unit 103 continually. The infrared sensors 102 output measurement values to the measurement value acquiring unit 103 continually. The measurement value acquiring unit 103 acquires the measurement values input from the capacitive sensors 101 and the measurement values input from the infrared sensors 102. The measurement value acquiring unit 103 outputs the acquired measurement values to the proximity determining unit 104. The proximity determining unit 104 determines whether a 3D gesture on the operation surface 301 is detected from the input measurement values. When a 3D gesture on the operation surface 301 is detected by the proximity determining unit 104, the proximity determining unit 104 outputs the measurement values of the capacitive sensors 101 and the measurement values of the infrared sensors 102 to the proximity area determining unit 105.

The proximity area determining unit 105 determines whether the area where the 3D gesture is detected is in one of the four corner areas of the operation surface 301 by referring to the measurement values of the capacitive sensors 101 and the measurement values of the infrared sensors 102 input thereto. Here, the four corner areas of the operation surface 301 are areas set in advance, the centers of which being located at the positions of the infrared sensors 102, respectively. For example, circular areas centered on the infrared sensors 102 and having a radius of a certain distance are set as the four corner areas of the operation surface 301. In a case where the area where the 3D gesture is detected is not in the four corner areas of the operation surface 301, the proximity area determining unit 105 further determines whether the perpendicular distance from the operation surface 301 to the detection position of the 3D gesture is less than a preset threshold value.

In a case where the perpendicular distance from the operation surface 301 to the detection area of the 3D gesture is less than the threshold value, the proximity area determining unit 105 outputs the measurement values of the capacitive sensors 101 to the coordinate value calculating unit 106. On the other hand, in a case where the perpendicular distance from the operation surface 301 to the detection area of the 3D gesture is greater than or equal to the threshold value, or in a case where the detection area of the 3D gesture is in one of the four corner areas of the operation surface 301, the proximity area determining unit 105 outputs the measurement values of the infrared sensors 102 to the coordinate value calculating unit 106.

The coordinate value calculating unit 106 calculates coordinate values indicating the proximity position of the operation body using the measurement values of the capacitive sensors 101 or the measurement values of the infrared sensors 102 input from the proximity area determining unit 105. The coordinate value calculating unit 106 outputs the calculated coordinate values to the output control unit 107. Here, the coordinate values calculated by the coordinate value calculating unit 106 are, for example, coordinate values indicating a position on the display 300. The output control unit 107 outputs the coordinate values calculated by the coordinate value calculating unit 106 to the display control device 200.

Next, an example of a hardware configuration of the proximity detection device 100 will be described.

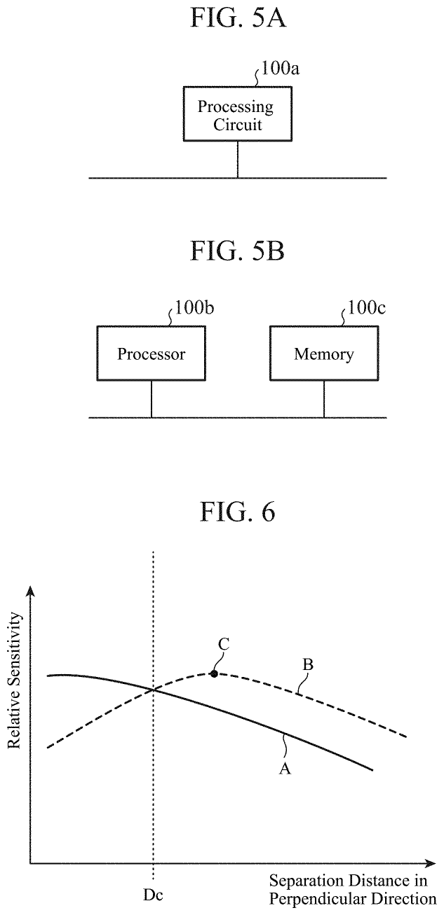

FIGS. 5A and 5B are diagrams illustrating exemplary hardware configurations of the proximity detection device 100.

The functions of the capacitive sensors 101, the infrared sensors 102, the measurement value acquiring unit 103, the proximity determining unit 104, the proximity area determining unit 105, the coordinate value calculating unit 106, and the output control unit 107 in the proximity detection device 100 are implemented by a processing circuit. That is, the proximity detection device 100 includes a processing circuit for implementing the above functions. The processing circuit may be a processing circuit 100a which is dedicated hardware as illustrated in FIG. 5A or may be a processor 100b for executing programs stored in a memory 100c as illustrated in FIG. 5B.

In the case where the measurement value acquiring unit 103, the proximity determining unit 104, the proximity area determining unit 105, the coordinate value calculating unit 106, and the output control unit 107 are implemented by dedicated hardware as illustrated in FIG. 5A, the processing circuit 100a corresponds to, for example, a single circuit, a composite circuit, a programmed processor, a parallel-programmed processor, an application specific integrated circuit (ASIC), a field-programmable gate array (FPGA), or a combination thereof. The functions of the measurement value acquiring unit 103, the proximity determining unit 104, the proximity area determining unit 105, the coordinate value calculating unit 106, and the output control unit 107 may be separately implemented by processing circuits, respectively, or may be implemented collectively by one processing circuit.

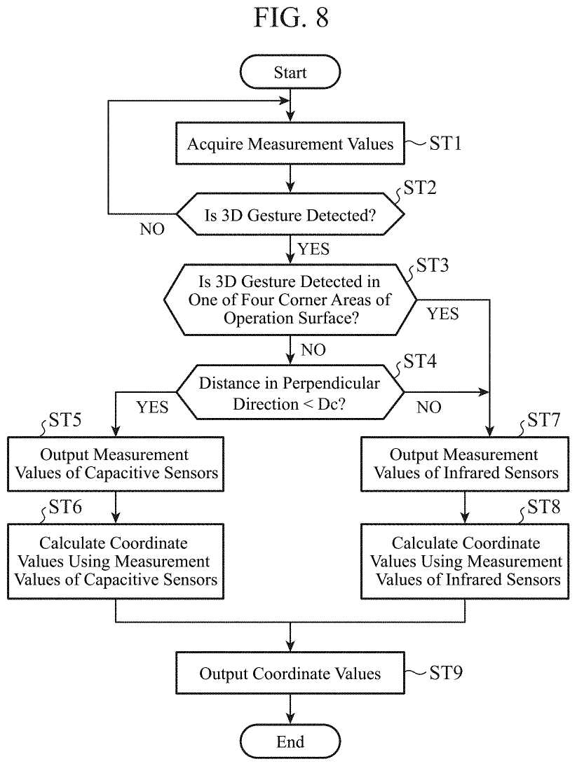

In the case where the measurement value acquiring unit 103, the proximity determining unit 104, the proximity area determining unit 105, the coordinate value calculating unit 106, and the output control unit 107 correspond to the processor 100b as illustrated in FIG. 5B, the functions of the respective units are implemented by software, firmware, or a combination of software and firmware. The software or the firmware is described as a program, which is stored in the memory 100c. The processor 100b reads and executes the program stored in the memory 100c and thereby implements the functions of the measurement value acquiring unit 103, the proximity determining unit 104, the proximity area determining unit 105, the coordinate value calculating unit 106, and the output control unit 107. That is, the measurement value acquiring unit 103, the proximity determining unit 104, the proximity area determining unit 105, the coordinate value calculating unit 106, and the output control unit 107 include the memory 100c for storing programs execution of which by the processor 100b results in execution of steps illustrated in FIG. 8 described later. It can also be said that these programs cause a computer to execute procedures or methods of the measurement value acquiring unit 103, the proximity determining unit 104, the proximity area determining unit 105, the coordinate value calculating unit 106, and the output control unit 107.

Here, the processor 100b may be, for example, a central processing unit (CPU), a processing device, an arithmetic device, a processor, a microprocessor, a microcomputer, a digital signal processor (DSP), or the like.

The memory 100c may be a nonvolatile or volatile semiconductor memory such as a random access memory (RAM), a read only memory (ROM), a flash memory, an erasable programmable ROM (EPROM), an electrically EPROM (EEPROM), a magnetic disk such as a hard disk or a flexible disk, or an optical disk such as a mini disk, a compact disc (CD) or a digital versatile disc (DVD).

Note that some part of the functions of the measurement value acquiring unit 103, the proximity determining unit 104, the proximity area determining unit 105, the coordinate value calculating unit 106, and the output control unit 107 may be implemented by dedicated hardware and the other part thereof may be implemented by software or firmware. In this manner, the processing circuit in the proximity detection device 100 can implement the above functions by hardware, software, firmware, or a combination thereof.

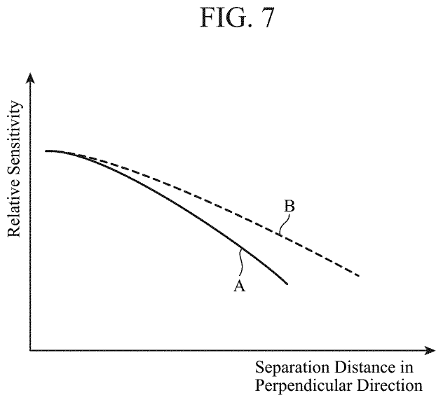

Next, the relative sensitivity of the capacitive sensors 101 and the infrared sensors 102 on the operation surface 301 will be explained with reference to FIGS. 6 and 7.

FIG. 6 is a graph illustrating the relationship between the relative sensitivity of the capacitive sensors 101 and the relative sensitivity of the infrared sensors 102 in an area other than the four corner areas of the operation surface 301 of the proximity detection device 100 according to the first embodiment. FIG. 7 is a graph illustrating the relationship between the relative sensitivity of the capacitive sensors 101 and the relative sensitivity of the infrared sensors 102 in the four corner areas of the operation surface 301 of the proximity detection device 100 according to the first embodiment. In each of FIGS. 6 and 7, the horizontal axis represents the separation distance of the operation body in the direction perpendicular to the operation surface 301, and the vertical axis represents the relative sensitivity of the capacitive sensors 101 and the infrared sensors 102. In each of FIG. 6 and FIG. 7, a curve A indicates the relative sensitivity of the capacitive sensors 101, and a curve B indicates the relative sensitivity of the infrared sensors 102.

First, the relative sensitivity of the sensors in an area other than the four corner areas of the operation surface 301 will be explained with reference to FIG. 6. As indicated by the curve A, the relative sensitivity of the capacitive sensors 101 decreases as the operation body is located farther from the operation surface 301 in the perpendicular direction. Likewise, as indicated by the curve B, the relative sensitivity of the infrared sensors 102 rises from the state in which the operation body is closest to the operation surface 301 in the perpendicular direction until the operation body is separated from the operation surface 301 by distance C, and then decreases as the operation body is located farther than the distance C in the perpendicular direction.

The curve A and the curve B intersect each other at the position of a perpendicular separation distance Dc. In an area where the perpendicular separation distance is shorter than Dc, the relative sensitivity of the capacitive sensors 101 is good, and in an area where the perpendicular separation distance is longer than Dc, the relative sensitivity of the infrared sensors 102 is good. The value of the separation distance Dc is set on the basis of an experimental value, an empirical value, or the like. The separation distance Dc serves as a threshold value used for determination on measurement values of which sensors are to be used when the proximity area determining unit 105 determines that the detection area of the 3D gesture is not in the four corner areas of the operation surface 301. The proximity area determining unit 105 determines whether to use measurement values of the capacitive sensors 101 or to use measurement values of the infrared sensors 102 using the threshold value Dc as a boundary point and switches the measurement values to be used.

Next, the relative sensitivity of the capacitive sensors 101 and the relative sensitivity of the infrared sensors 102 in the four corner areas of the operation surface 301 will be explained with reference to FIG. 7. As indicated by the curves A and B, the relative sensitivities of the capacitive sensors 101 and the infrared sensors 102 decrease as the operation body is separated farther from the operation surface 301 in the perpendicular direction. The relative sensitivities of the capacitive sensors 101 and the infrared sensors 102 have almost the same value when the operation body is closest to the operation surface 301 in the perpendicular direction. On the other hand, as the operation body is separated farther from the operation surface 301 in the perpendicular direction, the relative sensitivity of the infrared sensors 102 exceeds the relative sensitivity of the capacitive sensors 101. That is, the proximity area determining unit 105 determines to use measurement values of the infrared sensors 102 without switching measurement values to be used when it is determined that the detection area of the 3D gesture is in one of the four corner areas of the operation surface 301.

FIG. 8 is a flowchart illustrating an operation of the proximity detection device 100 according to the first embodiment.

In the flowchart of FIG. 8, it is assumed that the capacitive sensors 101 and the infrared sensors 102 detect a proximity object and output measurement values to the measurement value acquiring unit 103 continually.

When the measurement value acquiring unit 103 acquires measurement values from the capacitive sensors 101 and the infrared sensors 102 (step ST1), the acquired measurement values are output to the proximity determining unit 104. The proximity determining unit 104 determines whether a 3D gesture on the operation surface 301 is detected by referring to the input measurement values (step ST2). If no 3D gesture is detected (step ST2: NO), the process returns to step ST1 of the flowchart. On the other hand, if a 3D gesture is detected (step ST2: YES), the proximity determining unit 104 outputs the measurement values of the capacitive sensors 101 and the measurement values of the infrared sensors 102 to the proximity area determining unit 105.

The proximity area determining unit 105 determines whether the area where the 3D gesture is detected in the parallel direction is in one of the four corner areas of the operation surface 301 by referring the measurement values of the capacitive sensors 101 and the measurement values of the infrared sensors 102 input thereto (step ST3). If the detection area of the 3D gesture is not in the four corner areas of the operation surface 301 (step ST3: NO), the proximity area determining unit 105 further calculates the perpendicular distance between the operation surface 301 and the detected 3D gesture, and determines whether the calculated distance is less than a preset threshold value Dc (step ST4).

If the perpendicular distance between the operation surface 301 and the 3D gesture is less than the threshold value Dc (step ST4: YES), the proximity area determining unit 105 outputs the measurement values of the capacitive sensors 101 to the coordinate value calculating unit 106 (step ST5). The coordinate value calculating unit 106 calculates coordinate values indicating the proximity position of the operation body on the basis of the measurement values of the capacitive sensors 101 input thereto in step ST5 (step ST6).

On the other hand, if the perpendicular distance between the operation surface 301 and the 3D gesture is not less than the threshold value Dc (step ST4: NO), or if the detection area of the 3D gesture is in one of the four corner areas of the operation surface 301 (step ST3: YES), the proximity area determining unit 105 outputs the measurement values of the infrared sensors 102 to the coordinate value calculating unit 106 (step ST7). The coordinate value calculating unit 106 calculates coordinate values indicating the proximity position of the operation body on the basis of the measurement values of the infrared sensors 102 input thereto in step ST7 (step ST8). The coordinate value calculating unit 106 outputs the coordinate values calculated in step ST7 or step ST8 to the output control unit 107. The output control unit 107 outputs the coordinate values input from the coordinate value calculating unit 106 to the display control device 200 (step ST9) and ends the processing.

With the above processing, in the parallel direction of the operation surface 301, it becomes possible to use measurement values of suitable sensors on the basis of whether a 3D gesture is input to an area other than the four corner areas of the operation surface 301 or the 3D gesture is input to one of the four corner areas of the operation surface 301. Also in the perpendicular direction of the operation surface 301, it is possible to use measurement values of suitable sensors on the basis of how far in the perpendicular direction from the operation surface 301 the 3D gesture is detected.

In the configuration described above, measurement values of which sensors are to be used are determined depending on the relative sensitivities of the capacitive sensors 101 and the infrared sensors 102. Alternatively, the respective measurement values of the capacitive sensors 101 and the infrared sensors 102 may be weighted depending on the relative sensitivities of the capacitive sensors 101 and the infrared sensors 102 for use in the calculation of the coordinate values.

For example in FIG. 6, in a case where the separation distance of the operation body in the perpendicular direction with respect to the operation surface 301 is smaller than Dc, the proximity area determining unit 105 assigns a larger weighting value to the measurement values of the capacitive sensors 101 than to the measurement values of the infrared sensors 102, and outputs these measurement values of the both types of sensors to the coordinate value calculating unit 106. Likewise, for example in FIG. 6, in a case where the separation distance of the operation body in the perpendicular direction with respect to the operation surface 301 is greater than or equal to Dc, the proximity area determining unit 105 assigns a larger weighting value to the measurement values of the infrared sensors 102 than to the measurement values of the capacitive sensors 101, and outputs these measurement values of the both types of sensors to the coordinate value calculating unit 106.

In addition, the following configuration may be adopted: as the separation distance of the operation body in the perpendicular direction with respect to the operation surface 301 is changed from the threshold value Dc toward 0 in FIG. 6, the weighting of the measurement values of the capacitive sensors 101 is made to increase while the weighting value of the measurement values of the infrared sensors 102 is made to decrease. On the contrary, the following configuration may be adopted: as the separation distance of the operation body in the perpendicular direction with respect to the operation surface 301 increases beyond the threshold value Dc, the weighting of the measurement values of the infrared sensors 102 is made to increase while the weighting value of the measurement values of the capacitive sensors 101 is made to decrease.

In the above description, the capacitive sensors 101 and the infrared sensors 102 are arranged as illustrated in FIG. 1; however, the arrangement is not limited to that illustrated in FIG. 1. The arrangement positions of the capacitive sensors 101 and the infrared sensors 102 are determined depending on the intended use of the display 300.

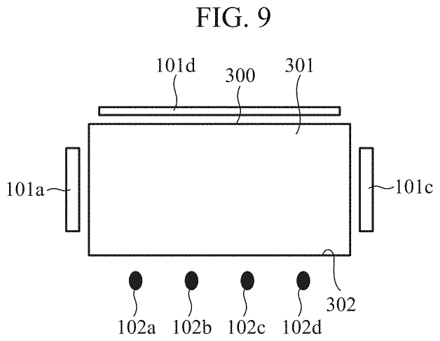

FIG. 9 is a diagram illustrating another exemplary arrangement of sensors included in the proximity detection device 100 according to the first embodiment.

For example, in a case where it is desired to increase the detection sensitivity of a 3D gesture in the perpendicular direction near the lower side 302 of the display 300, the four infrared sensors 102a, 102b, 102c, and 102d are arranged on the lower side 302 of the display 300. In addition, three capacitive sensors 101a, 101c, and 101d are arranged on the sides other than the side 302 of the display 300. With the arrangement illustrated in FIG. 9, it is possible to enhance the detection sensitivity for the operation body entering from the lower side of the display 300.

As described above, according to the first embodiment, the followings are included: at least one capacitive sensor 101 having a detection region that extends in a parallel direction with respect to an operation surface 301 for accepting a 3D gesture by an operation body, the detection region being in an area close to the operation surface 301; and at least one infrared sensor 102 having a detection region having directivity in a direction perpendicular to the operation surface 301. The at least one capacitive sensor 101 and the at least one infrared sensor 102 are arranged such that the 3D gesture by the operation body can be detected in the parallel direction and the perpendicular direction with respect to the operation surface 301. Thus, it is possible to detect the proximity of the operation body to the operation surface 301, to expand the detection region for detection of the proximity, and to enhance the detection accuracy.

Moreover, according to the first embodiment, a longitudinal direction of each of a plurality of capacitive sensors 101 included in the at least one capacitive sensor extends along a side of an outer circumference of the operation surface 301, and a plurality of infrared sensors 102 included in the at least one infrared sensor is arranged at corners of the operation surface 301, respectively, so as to sandwich each of the plurality of capacitive sensors 101 therebetween. Thus, it is possible to expand the detection region for detection of the proximity of the operation body to the operation surface 301 and to enhance the detection accuracy by efficient arrangement of the capacitive sensors and the infrared sensors. As a result, the cost for the sensors to be arranged can be suppressed.

Furthermore, according to the first embodiment, a plurality of infrared sensors 102 included in the at least one capacitive sensor is arranged along one side of an outer circumference of the operation surface 301, and a longitudinal direction of each of a plurality of capacitive sensors 101 included in the at least one capacitive sensor extends along another side of the outer circumference of the operation surface 301. Thus, the detection region of the 3D gesture can be covered efficiently by the efficient arrangement of the capacitive sensors and the infrared sensors.

In addition, according to the first embodiment, the followings are further included: a proximity determining unit 104 to detect the 3D gesture by the operation body from a measurement value of the at least one capacitive sensor 101 and a measurement value of the at least one infrared sensor 102; a proximity area determining unit 105 to perform determination of an area where the 3D gesture by the operation body is detected in the parallel direction and an area where the 3D gesture by the operation body is detected in the perpendicular direction with respect to the operation surface 301 when the 3D gesture by the operation body is detected, and to determine a measurement value of which one of the at least one capacitive sensor and the at least one infrared sensor is to be used on a basis of a result of the determination; and a coordinate value calculating unit 106 to calculate a position of the 3D gesture by the operation body using the determined measurement value. Thus, it is possible to calculate the position where the 3D gesture is performed using appropriate measurement values depending on the position of the operation body.

Furthermore, according to the first embodiment, the proximity area determining unit 105 determines a measurement value of which one of the at least one capacitive sensor 101 and the at least one infrared sensor 102 is to be used on a basis of a threshold value Dc of a separation distance of the operation body with respect to the operation surface 301 in the perpendicular direction which is set depending on the relative sensitivities of the at least one capacitive sensor 101 and the at least one infrared sensor 102, and on a basis of the separation distance of a position at which the 3D gesture by the operation body is detected with respect to the operation surface 301 in the perpendicular direction. Thus it is possible to calculate the position where the 3D gesture is performed using appropriate measurement values depending on the position of the operation body.

Furthermore, according to the first embodiment, the proximity area determining unit 105 performs weighting on the measurement value of the at least one capacitive sensor 101 and the measurement value of the at least one infrared sensor 102 depending on a separation distance of a position at which the 3D gesture by the operation body is detected with respect to the operation surface 301 in the perpendicular direction. Thus, it is possible to calculate the position where the 3D gesture is performed using appropriate measurement values depending on the position of the operation body.

Although the case where the operation surface 301 has a rectangular shape is described, the operation surface 301 may have another polygonal shape. In a case where the operation surface 301 has a polygonal shape, as exemplary arrangement corresponding to FIG. 1, infrared sensors 102 are arranged at corners of an operation surface 301, and capacitive sensors 101 are arranged so as to be sandwiched between two infrared sensors 102 with the longitudinal directions extending along multiple sides of the operation surface 301.

Note that the present invention can include modifications of any component of the embodiment, or omission of any component of the embodiment within the scope of the present invention.

### INDUSTRIAL APPLICABILITY

A proximity detection device according to the present invention is applicable to onboard devices, mobile terminals, electric appliances, and the like that enables input of operation by proximity of an operation body to an operation surface.

### REFERENCE SIGNS LIST

100: proximity detection device, 101, 101a, 101b, 101c, 101d: capacitive sensor, 102, 102a, 102b, 102c, 102d: infrared sensor, 103: measurement value acquiring unit, 104: proximity determining unit, 105: proximity area determining unit, 106: coordinate value calculating unit, 107: output control unit

1. A proximity detection device comprising:
at least one capacitive sensor having a detection region that extends in a parallel direction with respect to an operation surface for accepting a 3D gesture by an operation body, the detection region being in an area close to the operation surface; and
at least one infrared sensor having a detection region having directivity in a direction perpendicular to the operation surface,
wherein the at least one capacitive sensor and the at least one infrared sensor are arranged such that the 3D gesture by the operation body can be detected in the parallel direction and the perpendicular direction with respect to the operation surface.

2. The proximity detection device according to claim 1,
wherein a longitudinal direction of each of a plurality of capacitive sensors included in the at least one capacitive sensor extends along a side of an outer circumference of the operation surface, and
a plurality of infrared sensors included in the at least one infrared sensor is arranged at corners of the operation surface, respectively, so as to sandwich each of the plurality of capacitive sensors therebetween.

3. The proximity detection device according to claim 1,
wherein a plurality of infrared sensors included in the at least one capacitive sensor is arranged along one side of an outer circumference of the operation surface, and
a longitudinal direction of each of a plurality of capacitive sensors included in the at least one capacitive sensor extends along another side of the outer circumference of the operation surface.

4. The proximity detection device according to claim 1, comprising a circuitry
to detect the 3D gesture by the operation body from a measurement value of the at least one capacitive sensor and a measurement value of the at least one infrared sensor;
to perform processes including: determination of an area where the 3D gesture by the operation body is detected in the parallel direction and an area where the 3D gesture by the operation body is detected in the perpendicular direction with respect to the operation surface when the 3D gesture by the operation body is detected by the proximity determining unit; and to determine a measurement value of which one of the at least one capacitive sensor and the at least one infrared sensor is to be used on a basis of a result of the determination; and
to calculate a position of the 3D gesture by the operation body using the measurement value determined on a basis of the result of the determination.

5. The proximity detection device according to claim 4, wherein in the processes, a measurement value of which one of the at least one capacitive sensor and the at least one infrared sensor is to be used is determined on a basis of a threshold value of a separation distance of the operation body with respect to the operation surface in the perpendicular direction which is set depending on the relative sensitivities of the at least one capacitive sensor and the at least one infrared sensor, and on a basis of the separation distance of a position at which the 3D gesture by the operation body is detected with respect to the operation surface in the perpendicular direction.

6. The proximity detection device according to claim 4, wherein in the processes, the measurement value of the at least one capacitive sensor and the measurement value of the at least one infrared sensor are weighted on depending on a separation distance of a position at which the 3D gesture by the operation body is detected with respect to the operation surface in the perpendicular direction.

7. A proximity detection method comprising:
a step of detecting, by a proximity determining unit, a 3D gesture by an operation body from a measurement value of a capacitive sensor having a detection region extending in a parallel direction with respect to an operation surface for accepting the 3D gesture by the operation body, the detection region being in an area close to the operation surface and a measurement value of an infrared sensor having a detection region having a directivity in a perpendicular direction with respect to the operation surface, the capacitive sensor and the infrared sensor being arranged to be able to perform detection in the parallel direction and in the perpendicular direction;
a step of performing, by a proximity area determining unit, determination of an area where the 3D gesture by the operation body is detected in the parallel and perpendicular directions with respect to the operation surface when the 3D gesture by the operation body is detected, and determining a measurement value of which one of the capacitive sensor and the infrared sensor is to be used on a basis of a result of the determination; and
a step of calculating, by a coordinate value calculating unit, a position of the 3D gesture by the operation body using the measurement value being determined.
